(19) United States
(12) Patent Application Publication
(10) Pub. No.: US 2009/0020904 A1
(43) Pub. Date: Jan. 22, 2009

(54) SILICONE-FREE CUTTING OIL AND USE THEREOF

(76) Inventors: Torsten HENNING, Hanau (DE); Anja Kindling, Kreuzau (DE); Rudiger Landers, Essen (DE)

Correspondence Address: FROMMER LAWRENCE & HAUG, 745 FIFTH AVENUE- 10TH FL., NEW YORK, NY, 10151, US

(21) Appl. No.: 12/174,799

(22) Filed: Jul. 17, 2008

(30) Foreign Application Priority Data
Jul. 18, 2007 (DE) 102007033430.5

(51) Int. Cl. B29C 70/28; C08G 59/00; C08K 5/17

(52) U.S. Cl. 264/160; 524/612; 524/186

(57) ABSTRACT

The invention relates to a cutting oil comprising A) at least one polyalkylene glycol and B) optionally solvent and C) optionally further auxiliary materials and additives, and to its use for sawing polyurethane foams.

This application claims benefit under 35 U.S.C. 119(a) of German patent application DE 10 2007 03 3430.5, filed on 18 Jul. 2007.

Any foregoing applications, including German patent application DE 10 2007 03 3430.5, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to silicone-free cutting oils and to their use in cutting or drilling equipment (such as a circular saw, a bandsaw and a power drill), for example in the sawing of polyurethane foams (such as slabstock polyurethane foams or rigid polyurethane foams, and to the production of items of furniture with such polyurethane foam parts, which exhibit good results in burning tests.

Sawing equipment requires cutting oils in order to lower the friction between saw blade or saw band and the body to be divided. For example, bandsaw equipment is used in the processing of polyurethane slabstock foams. The friction between saw and polyurethane foam is particularly high, and so a cutting oil is always required.

Typically, the cutting oils used are silicone oils, for example polydimethylsiloxanes having a viscosity of 5 to 1000 mPa·s, measured at 25° C. Frequently, high demands with regard to fire protection are made on the cut polyurethane foam parts, in particular when the foam parts are processed further to produce items of furniture, for example mattresses or seating furniture. It is found that foam parts which have been produced with silicone-containing cutting oils achieve poor results in fire tests.

It was therefore an object of the present invention to provide alternative cutting oils for polyurethane foams (such as slabstock polyurethane foams or rigid polyurethane foams), which preferably adversely affect the results of fire tests on polyurethane foam parts cut with them only to a low degree, if at all.

It has now been found that, surprisingly, polyalkylene glycols can be used as cutting oils or in cutting oils and that these cutting oils which comprise polyalkylene glycols, optionally solvents and optionally further auxiliary materials and additives achieve this object.

The use in accordance with the invention of polyalkylene glycols as or in cutting oils and the cutting oils themselves has/have the advantage that the silicone-free cutting oils of the invention are found to be equivalent to classical silicone oil with regard to the lubricity but have a significantly better combustion behaviour.

The cutting oils of the invention and their use are described by way of example hereinafter, without any intention that the invention be restricted to these illustrative embodiments. When ranges, general formulae or compound classes are specified hereinafter, these shall encompass not only the appropriate ranges or groups of compounds which are mentioned explicitly but also all subranges and subgroups of compounds which can be obtained by selecting individual values (ranges) or compounds. When documents are cited in the present description, their content shall be incorporated fully into the disclosure-content of the present invention.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The invention therefore provides silicone-free cutting oils comprising,

A) at least one polyalkylene glycol and
B) optionally solvent and
C) optionally further auxiliary materials and additives.

In another embodiment of the invention provides silicone-free cutting oils consisting essentially of,

A) at least one polyalkylene glycol and
B) optionally solvent and
C) optionally further auxiliary materials and additives.

In still another embodiment of the invention provides silicone-free cutting oils consisting of,

A) at least one polyalkylene glycol and
B) optionally solvent and
C) optionally further auxiliary materials and additives.

In the context of the present invention, silicone-free is understood to mean that no compounds which have Si—C or Si—O—C bonds are present or are present in an amount that is below any reasonable detection limit.

Preferably, the cutting oils comprise, or preferably consist of:
A) 1 to 100% by weight of polyalkylene glycol and
B) 0 to 99% by weight of solvents and
C) 0 to 50% by weight of further auxiliary materials and additives.

The cutting oils preferably comprise or consist of:
A) 1 to 99.98% by weight of at least one polyalkylene glycol and
B) 0.01 to 98% by weight of at least one solvent and/or
C) 0.01 to 50% by weight of at least one auxiliary materials and/or additive.

The cutting oils more preferably comprise or consist of:
A) 1 to 99.8% by weight of at least one polyalkylene glycol and
B) 0.1 to 98% by weight of at least one solvent and/or
C) 0.1 to 50% by weight of at least one auxiliary materials and/or additive.

The polyalkylene glycols present in the cutting oils of the invention are preferably ethylene oxide/propylene oxide copolymers, which are preferably obtainable by copolymerizing ethylene oxide (EO) and propylene oxide (PO) with a polyhydric alcohol.

The cutting oils of the invention preferably comprise polyalkylene glycols which have been prepared with glycerol, trimethylolpropane, pentaerythritol, diglycerol, triglycerol, ditrimethylolpropane, dipentaerythritol or sorbitol, most preferably pentaerythritol, as the polyhydric starter alcohol.

The polyalkylene glycols present in the cutting oils of the invention preferably have an EO/PO weight ratio of 80:20 to 40:60, preferably of 80:20 to 70:30 and more preferably of 75:25.

The polyalkylene glycols preferably have a mean molar mass of 2000 to 30 000 g/mol, more preferably of 3500 to 20 000 g/mol and most preferably of 5000 to 7500 g/mol. In the context of the invention, mean molar mass refers to number average molecular weight. The number average molecular weight can be measured by gel permeation chromatography (GPC).

The polyalkylene glycols present in the inventive cutting oils are preferably miscible with water in any ratio.

The polyalkylene glycols which are present in the inventive cutting oils may, for example, be commercially available polyalkylene glycols, for example Polyglykol P41/300, Polyglykol P41/3000 or Polyglykol P41/12000 from Clariant.

Polyalkylene glycols (frequently also referred to as polyoxyalkylenes), which may be present as the polyalkylene glycol in the cutting oil of the invention, can be prepared as described in the prior art, for example in Ullmann's encyclopedia of industrial chemistry, Vol. A21, 5th completely revised edition 1992, VCH Verlagsgesellschaft GmbH, Weinheim, pages 579 to 589 and the literature cited there. The polyalkylene glycols are preferably prepared under alkaline catalysis and more preferably with pentaerythritol as the starter alcohol.

Since the polyalkylene glycols exhibit outstanding lubricant properties even in very low concentrations, the cutting oil, as well as polyalkylene glycol, may also comprise one or more solvents. The cutting oil preferably comprises 1 to 99% by weight, preferably 50 to 90% by weight, of solvent(s) B). A preferred solvent is water.

As well as the polyalkylene glycol and optionally the solvent, the inventive cutting oil may comprise one or more auxiliary materials and/or additives C). Preferred auxiliary materials and/or additives C) may, for example, be customary preservatives such as bactericides or fungicides, e.g. Euxyl® 100, supplier: Schülke & Mayr, or Mergal® K 12, supplier: Troy; antioxidants, e.g. Irganox® 1520 L, manufacturer: Ciba, or butylhydroxyanisole; amines, e.g. triethanolamine, and anticorrosives, e.g. Hostacor® IT, manufacturer: Clariant.

Particularly preferred cutting oils comprise or consist of:
A) 50 to 99.9% by weight, especially 95 to 99.9% by weight, of at least one polyalkylene glycol and
C) 0.1 to 5% by weight of at least one amine, preferably triethanolamine.

Very particularly preferred cutting oils comprise or consist of:
A) 99.0 to 99.8% by weight of a polyalkylene glycol and
C) 0.2 to 1.0% by weight of at least one amine, preferably triethanolamine.

The invention further provides for the use of the inventive cutting oils in sawing equipment, preferably in bandsaw equipment and more preferably in bandsaw equipment for/in the sawing of polyurethane foams or polyurethane slabstock foams.

The present invention also provides cut-to-size polyurethane foam parts obtained by sawing, especially bandsawing, of polyurethane foams using inventive cutting oil, and also the use of the cut-to-size polyurethane foam parts of the invention for producing articles with good burning properties, for producing items of furniture and especially for producing items of furniture with good burning properties. Good burning properties are understood to mean that the polyurethane foam parts pass the fire test of ASTM D 1692 (distance burnt not more than 125 mm).

In the examples adduced below, the present invention is described by way of example, without any intention that the invention, whose scope of protection is evident from the description as a whole and the claims, be restricted to the embodiments specified in the examples.

### EXAMPLES

List of substances used:
Polyglykol P 41/300=polyalkylene glycol, mean molar mass 5000, manufacturer: Clariant
Polyglykol P 41/3000=polyalkylene glycol, mean molar mass 15 000, manufacturer: Clariant
Polyglykol P 41/12000=polyalkylene glycol, mean molar mass 20 000, manufacturer: Clariant
Wacker® Siliconoel AK 100=polydimethylsiloxane, viscosity at 25° C.: 96 mPa·s, manufacturer: Wacker

### Example 1

Cutting oil of the invention, silicone-free, consisting of 99.5% by weight of Polyglykol P 41/300, 0.5% by weight of triethanolamine.

### Example 2

Cutting oil of the invention, silicone-free, consisting of 49.5% by weight of Polyglykol P 41/3000, 50% by weight of water, 0.5% by weight of triethanolamine.

### Example 3

Cutting oil of the invention, silicone-free, consisting of 10% by weight of Polyglykol P 41/12000, 89.5% by weight of water, 0.5% by weight of triethanolamine.

### Comparative Example A

100% by weight of Wacker® Siliconoel AK 100.

### Sawing Tests:

The saw band of a bandsaw was coated with the particular cutting oil by rubbing it in with a saturated cloth, and then the number of cutting operations which were possible before viscoelastic slabstock foam started to break owing to excessively high friction during the cutting was determined.

### Fire Tests to ASTM D 1692:

Foam parts of the specified size (150 mm×50 mm×13 mm) were sprayed with the example cutting oils (in each case approx. 10 g) and dried at room temperature for 48 h. The results of the ASTM D 1692 fire test, in which the test specimen lies horizontally on a screen and a flame acts from below for 60 seconds, are specified in distance burnt (max. 125 mm) (Table 1).

TABLE 1
Results of the sawing tests and fire tests

| Separating | Number of possible | ASTM D 1692 results |
|---|---|---|
| agent | cutting operations | distance (mm) |
| 1 | 8 | 102 |
| 2 | 8 | 110 |
| 3 | 7 | 120 |
| A | 8 | >125, test failed |

### Evaluation of the Tests:

As is evident from the above Table 1, the silicone-free cutting oils used in accordance with the invention are equivalent to classical silicone oil with regard to the lubricity, but exhibit significantly better properties in the fire test to ASTM D 1692.

Having thus described in detail various embodiments of the present invention, it is to be understood that many apparent variations thereof are possible without departing from the spirit or scope of the present invention.

1. A silicone-free cutting oil comprising:
A) 1 to 99.98% by weight of at least one polyalkylene glycol and
B) 0.01 to 98% by weight of at least one solvent and/or
C) 0.01 to 50% by weight of at least one auxiliary materials and/or additive.

2. The cutting oil according to claim 1, consisting of
A) 1 to 99.8% by weight of at least one polyalkylene glycol and
B) 0.1 to 98% by weight of at least one solvent and/or
C) 0.1 to 50% by weight of at least one auxiliary materials and/or additive.

3. The cutting oil according to claim 2 comprising at least one polyalkylene glycol having an EO/PO weight ratio of 80:20 to 40:60.

4. The cutting oil according to claim 3, characterized in that at least one polyalkylene glycol which has a mean molar mass of 2000 to 30 000 is present.

5. The cutting oil according to claim 4, characterized in that at least one polyalkylene glycol which has glycerol, trimethylolpropane, pentaerythritol, diglycerol, triglycerol, ditrimethylolpropane, dipentaerythritol or sorbitol as the polyhydric starter alcohol is present.

6. The cutting oil according to claim 5, characterized in that at least one polyalkylene glycol has pentaerythritol as the polyhydric starter alcohol.

7. The cutting oil according to claim 4, wherein
A) 50 to 99.9% by weight of at least one polyalkylene glycol and
C) 0.1 to 5% by weight of at least one amine.

8. The cutting oil according to claim 7, wherein
A) 99.0 to 99.8% by weight of a polyalkylene glycol and
C) 0.2 to 1.0% by weight of at least one amine.

9. The cutting oil according to claim 7, wherein
A) 95 to 99.9% by weight of at least one polyalkylene glycol and
C) 0.1 to 5% by weight of triethanolamine.

10. The cutting oil according to claim 8, wherein the at lease one amine is triethanolamine.

11. The silicone-free cutting oil of claim 3, wherein
A) 1 to 99.98% by weight of at least one polyalkylene glycol and
B) 0.01 to 98% by weight of at least one solvent and/or
C) 0.01 to 50% by weight of at least one auxiliary materials and/or additive.

12. The cutting oil according to claim 3, wherein
A) 1 to 99.8% by weight of at least one polyalkylene glycol and
B) 0.1 to 98% by weight of at least one solvent and/or
C) 0.1 to 50% by weight of at least one auxiliary materials and/or additive.

13. A method of cutting a polyurethane foam starting product with a cutting device into cut-to-size polyurethane foam parts as end products with enhanced fire resistance which comprises adding the cutting oil of claim 1 to the cutting device.

14. The method of claim 13, wherein the cutting device is a bandsaw and the starting product is silicone foam slabstock.

15. The cut-to-size polyurethane foam parts obtained by the method of claim 13.

16. A method of enhancing the fire resistance of an article of manufacture which comprises adding the cut-to-size polyurethane foam parts of claim 15 to the article of manufacture.

17. The method of claim 16, wherein the article of manufacture is furniture.
